(19) United States
(12) Patent Application Publication
(10) Pub. No.: US 2026/0291910 A1
(43) Pub. Date: Sep. 24, 2026

(54) NETWORK SERVICES ACROSS MULTIPLE NETWORK DEVICES

(71) Applicant: HEWLETT PACKARD ENTERPRISE DEVELOPMENT LP, Spring, TX (US)

(72) Inventor: Venkata Varadhan Devarajan, Bangalore (IN)

(21) Appl. No.: 19/213,530

(22) Filed: May 20, 2025

(30) Foreign Application Priority Data
Mar. 21, 2025 (IN) 202541026224

(51) Int. Cl. H04L 61/255; H04L 61/5061

(52) U.S. Cl. CPC H04L 61/255; H04L 61/5061

(57) ABSTRACT

In certain examples, a method includes receiving, at a non-owner network device of a set of network devices implementing a network service, a first network data unit of a network flow; recognizing, by the non-owner network device, an identifying characteristic of the first network data unit, wherein the identifying characteristic is related to the network service; transmitting, based on the recognition of the identifying characteristic and using a network tunnel, the first network data unit to a network service management owner of the set of network devices; identifying, by the network service management owner, the first network data unit as corresponding to the network service; and processing, by the network service management owner, the first network data unit to perform the network service.

### BACKGROUND

Computing devices often access networks (e.g., the Internet). Such access is often facilitated using network devices. In some scenarios, such network devices may implement a variety of network services (e.g., a network address translation (NAT) service).

### BRIEF DESCRIPTION OF THE DRAWINGS

Certain examples discussed herein will be described with reference to the accompanying drawings listed below. However, the accompanying drawings illustrate only certain aspects or implementations of examples described herein by way of example, and are not meant to limit the scope of the claims. Aspects of the present disclosure are best understood from the following detailed description when read with the accompanying figures. For a more complete understanding of this disclosure, and advantages thereof, reference is now made to the following descriptions taken in conjunction with the accompanying drawings, in which:

FIG. 1 shows a block diagram of a system for implementing a network service across multiple network devices in accordance with one or more examples disclosed herein;

FIG. 2 shows a flow diagram of an example interaction between network devices implementing a network service in accordance with one or more examples disclosed herein;

FIG. 3 illustrates an overview of an example method 300 for implementing a network service across multiple network device in accordance with one or more examples disclosed herein;

FIG. 4 illustrates a block diagram of a computing device, in accordance with one or more examples disclosed herein; and

FIG. 5 illustrates a block diagram of a computing device, in accordance with one or more examples disclosed herein.

### DESCRIPTION

The following disclosure provides many different examples for implementing different features. Specific examples of components and arrangements are described below to simplify the present disclosure. These are, of course, merely examples and are not intended to be limiting.

Computing devices often access networks (e.g., the Internet). Such access is often facilitated using network devices. Network devices are sometimes deployed in a manner that provides redundancy, such as redundant connections from one network device to other network devices, in order to more robustly provide for such connections.

As an example, client computing devices may be operatively connected to an access network device, which may, for example, provide layer-2 (L2) bridging functionality for connected computing devices. To facilitate access to other networks, a particular access network device may be connected to two or more aggregation network devices, which may, for example, collectively serve as a gateway to connect to the other networks (e.g., the Internet). In such a deployment, the access network device may have one connection to each of the two or more aggregation network devices (thereby providing redundancy), and the connections (e.g., links) to the separate aggregation network devices may form an aggregation group (e.g., a Link Aggregation Group (LAG)), also sometimes referred to as a multi-chassis (MC) LAG (MC-LAG)).

Each aggregation group may be associated with an identifier of the aggregation group (e.g., an Ethernet Segment Identifier (ESI)). As an example, a particular LAG (e.g., a set of redundant links from an access network device to multiple aggregation network devices) may be associated with a particular ESI (e.g., ESI 100, ESI 200, and the like). The various links from the access network device to the aggregation network devices may serve to provide redundancy of access, for example, if one of the links in the aggregation group stops functioning properly for any reason (e.g., cable disconnection, transceiver failure, aggregation network device failure, and the like). While any number of techniques may exist for grouping redundant connections to aggregation layer devices from a particular access switch, any of which may be used without departing from the scope of examples disclosed herein, for ease of explanation, such aggregation groups may be referred to herein generally as LAGs. Such a deployment configuration may be used, for example, in an Ethernet Virtual Private Network (EVPN) multi-homed (MH) (EVPN-MH) deployment scenario.

The aggregation network devices may be configured to communicate with one another to share identifiers of LAGs (e.g., EVIs) for which they have at least one link. Thus, each aggregation network device that has a link for a particular LAG may become aware of the other aggregation network devices that also have a link for the same LAG. Aggregation network devices that serve a common LAG having a particular identifier may form a set of network devices that, as an example, collectively function as a gateway for the aggregation group to external networks.

Accordingly, outbound network traffic transmitted from client computing devices, and received at one of the aggregation network devices from an access network device to which the client computing device is connected, may be transmitted from any one of the aggregation network devices (e.g., whichever of the aggregation network devices received the network traffic). Similarly, inbound traffic destined for a client computing device that may be received at any one of the aggregation network devices serving a LAG, and the aggregation network device that receives the inbound network traffic may provide the network traffic to an access network device to which the client computing device is connected, which in turn transmits the network traffic to the client computing device. Which aggregation network device is used for inbound and/or outbound network data units (e.g., packets) of the network traffic may be determined (e.g., on a per-network data unit basis) using any suitable policy for distributing network traffic among redundant aggregation network devices (e.g., various load balancing policies).

In such scenarios, the set of aggregation network devices that service a given LAG may be configured to implement any number of network services for the LAG, such as, for example, network address translation (NAT) services. As an example, a NAT service may allow any number of underlying devices in a private network to access outside networks using a pool of public Internet Protocol (IP) addresses and port numbers, which may be referred to as a NAT pool.

Specifically, a network device implementing a NAT service may maintain a pool of IP addresses and port numbers. When a network flow (e.g., network traffic communicated between two endpoint devices) is initiated (e.g., via receipt of a network data unit from an underlying client computing device destined for some other device in another network), the NAT service may perform a lookup in a NAT table to determine if a NAT IP address and port number from the NAT pool has been assigned to the client computing device for the network flow. Because the network flow is being initiated (e.g., the first network data unit in the network flow), the NAT lookup may result in a NAT lookup miss.

In the event of a NAT lookup miss, the NAT service may select a NAT IP address and port number from the NAT pool, assign the NAT IP address and port number to the IP address and port number corresponding to the client computing device and used for the network flow (which may be referred to as making a NAT assignment), and update its NAT table to reflect the NAT assignment. From that point on, during the network flow, network data units of the network flow from the client computing device are updated (e.g., translated) to include the NAT IP address and port number rather than the source IP address and port number of the client computing device. A similar process may happen in reverse for network data units of a network flow that are destined for the client computing device.

Thus, the NAT service may function to translate the source IP address and port number to a NAT IP address and port number for outbound network flow traffic from a client computing device, and, similarly, translate the NAT IP address and port number back to the source IP address and port number for inbound network flow traffic to a client computing device.

As an example, a computing device seeking to communicate with another device over the Internet may send a network data unit (e.g., a packet) to an access network device to which the computing device is connected. The network data unit may include (among other items of information) the IP address of the device with which communication is sought as a destination IP address, an IP address of the sending computing device as a source IP address, and a source port number. The access network device may transmit (e.g., based on a load balancing policy) the network data unit to an aggregation network device of a set of aggregation network devices to which the access network device is connected via a set of links that form a LAG.

Upon receiving a network data unit from the underlying computing device (e.g., via the access network device), an aggregation network device implementing a NAT service may perform a NAT lookup to determine if its NAT table includes an entry matching the source IP address and port number. When such an entry exists, the source IP address and port number of the network data unit may be replaced with a NAT IP address and port number assigned to the IP address of the computing device (e.g., the initial source IP address of the network data unit) from a pool of NAT IP addresses and corresponding port numbers, which was previously assigned as part of a NAT assignment. The updated network data unit may then be transmitted on towards its destination.

A similar process happens in reverse for incoming network traffic. When an aggregation network device receives a network data unit, the destination IP address may be the NAT IP address assigned to a source IP address of a computing device. The NAT IP address is used to lookup the IP address and port number of the computing device, and the network data unit is updated to include that IP address and port number rather than the NAT IP address and port number as the destination IP address and port number. The aggregation network device may then transmit the network data unit to the access network device, which may then forward the network data unit to the appropriate computing device corresponding to the destination IP address and port number.

In scenarios in which a set of aggregation network devices service a particular LAG, a NAT service may be implemented. Thus, the NAT service may be implemented across the set of aggregation network devices serving the LAG. Because any of the aggregation network devices implementing the NAT service may be transmitting to or receiving from remote devices for network flows, one of the aggregation network devices may be elected as a NAT pool management owner for the NAT service. The election may be performed using any suitable election technique (e.g., lowest switch virtual interface (SVI) IP number).

The NAT pool management owner is responsible for assigning NAT IP addresses and port numbers from a pool of the same allocated for the NAT service (e.g., the NAT pool). As discussed above, such assignments are often made when a computing device initiates a network flow (e.g., sends the first network data unit in a network flow using its IP address as the source IP address and using a particular port number as a source port number). The NAT pool management owner may make the assignment, and then communicate the assignment to the other aggregation network devices servicing the LAG. Each aggregation network device (e.g., the NAT pool management owner and the non-owner devices) may update their respective NAT tables, and subsequent network data units in the network flow may then use the NAT IP address and port number, regardless of which aggregation layer device receives the subsequent network data units. For a set of aggregation network devices implementing a NAT service for a LAG, any aggregation network device that is not elected as the NAT pool management owner may be referred to as a non-owner network device. Thus, a non-owner network device for a NAT service may be any aggregation network device serving the LAG and implementing the NAT service, but that is not the elected NAT pool management owner.

However, to facilitate the above-described use of the NAT service for a LAG, when any non-owner aggregation network device receives an initial network data unit of a network flow, and attempts to perform a NAT lookup using its NAT table, the result may be a NAT lookup miss (e.g., rather than a NAT lookup hit that would result for subsequent network data units when the NAT table is already updated). In the event of a NAT lookup miss on a non-owner network device, the non-owner network device has to communicate with the NAT pool management owner for the NAT service to get the NAT assignment with which to update its NAT table. Such communication between the non-owner network device and the NAT pool management owner is often facilitated, for example, by the non-owner network device trapping the network data unit, and obtaining a portion of the information from the network data unit (e.g., source IP address and port number). The obtained information may then be provided to software executing on one or more processors of the non-owner network device. Such software may be configured to communicate with corresponding software executing on one or more processors of the NAT pool management owner, which then, to perform the NAT assignment, selects an available NAT IP address and port number from the NAT pool, programs the NAT assignment into its own NAT table, and communicates the assignment back to the non-owner device from which the request was received (and to any other non-owner network devices servicing the LAG). The non-owner network device then updates its own NAT table, and, finally, is able to update the network data unit, and send the updated network data unit towards its destination.

Implementing network services on multiple aggregation network devices for a LAG may present several performance problems. Such problems may be caused, for example, by different network devices servicing a LAG receiving network traffic of a network flow for which a network service is to be implemented. As an example, in a case where a NAT lookup on a given aggregation network device is successful, the lookup (and other relevant lookups and actions) are often performed in hardware of the network device along a datapath (e.g., a network data unit may be processed and transmitted without the need to invoke software of the non-owner network device and the NAT pool management owner to obtain a NAT assignment before sending the network data unit). Thus, latency introduced by the NAT lookup is relatively low.

When a NAT lookup miss occurs on a NAT pool management owner, the NAT pool management owner has to make the NAT assignment, introducing a small amount of additional latency. However, the latency, and other metrics, such as NAT connections per second (CPS), still represent an acceptable level of performance.

On the other hand, when non-owner network devices experience a NAT lookup miss, higher latency and a lower CPS metric result from the fact that, before a network data unit may be sent towards a destination, an additional, software-based communication must necessarily occur between the non-owner aggregation network device and the NAT pool management owner. Specifically, the non-owner network device must communicate a request for a NAT assignment to the NAT pool management owner, and receive the NAT assignment from the NAT pool management owner, before the network data unit may be transmitted. Such actions increase the latency for transmission of network data units from non-owner network devices, and reduce the CPS metric for the NAT service.

Examples disclosed herein address at least the above-described performance issues resulting from implementing a network service on multiple, separate network devices. Specifically, in one or more examples, a set of network devices may be configured such that, when a non-owner device for a network service receives a network data unit relevant to a particular network service, the non-owner device may transmit the network data unit (e.g., via a network tunnel) to an owner device of the network service (e.g., a NAT pool management owner) for further processing relevant to the service. Thus, the owner network device may process the network data unit received via the network tunnel to facilitate implementation of the network service, and then communicate information about the processing back to the non-owner network device from which the network data unit was received, as well as to other non-owner network devices of the set of network devices implementing the network service.

As an example, non-owner network devices for a LAG that implement a NAT service may be configured to, in the event of a NAT lookup miss, cause the network data unit that caused the NAT lookup miss to be directly communicated to the NAT pool management owner (e.g., rather than sending a request for a NAT assignment).

As an example, the aggregation network devices for a LAG may be configured with a virtual tunnel endpoint (VTEP) function (e.g., in a Virtual eXtensible Local Area Network (VXLAN) environment). The VTEP may encapsulate the network data unit using various items of information (e.g., including, but not limited to, a VXLAN network identifier (VNI)). The encapsulated network data unit may then be transmitted directly (e.g., using a dedicated VXLAN tunnel) to the NAT pool management owner (e.g., to a designated recirculation port of the NAT pool management owner).

The NAT pool management owner may then identify the network traffic unit (e.g., using the VNI and/or any other relevant item of information in the encapsulated network data unit) as a network data unit for which NAT service (e.g., a NAT assignment) is required. In response, the network data unit may be decapsulated (e.g., by a VTEP executing on the NAT pool management owner), and provided to the data path of the NAT pool management owner, as if, for example, it had originally been received by the NAT pool management owner.

The NAT pool management owner may then perform a NAT lookup, which results in a NAT lookup miss. The NAT pool management owner, in response to the NAT lookup miss, may make a NAT assignment for the network data unit, and update its NAT table to reflect the same. The network data unit may then be updated based on the NAT assignment, and sent towards its destination, from the NAT pool management owner. Separately, the NAT pool management owner may communicate the NAT assignment to the non-owner network devices for the LAG, so that the non-owner network devices may update their corresponding NAT tables, and use the information therein for future network data units of the network flow.

The above-described process for NAT assignments may lower latency and increase CPS values for communication from computing devices through aggregation network devices of a LAG, where the set of aggregation network devices are implementing a NAT service. The improvement may result, for example, from an elimination of a bi-directional, software-based communication between the non-owner aggregation network device and a NAT pool management owner to facilitate NAT assignments being provided from the NAT pool management owner to a non-owner network device before a network data unit may be transmitted.

Instead, using examples disclosed herein, a NAT lookup miss on a non-owner network device for a network data unit may result in transmission of an encapsulated network data unit via a network tunnel (e.g., a VXLAN tunnel) to the NAT pool management owner, which may decapsulate the encapsulated network data unit to obtain the original network data unit, make the NAT assignment, transmit the network data unit towards its destination, and send the NAT assignment information to the non-owner aggregation network devices of the LAG.

Thus, transmission of the network data unit does not need to wait on the return communication from the NAT pool management owner of the NAT assignment. Additionally, the communication of the network data unit to the NAT pool management owner via the VXLAN tunnel uses a faster hardware data path of the non-owner aggregation network device and the NAT pool management owner instead of a slower interaction between the two devices using software executing on processors of the two devices to facilitate the NAT assignment.

Although the above description uses an example of implementation of the solution in an environment where multiple aggregation network devices are serving a particular LAG for which a NAT service is implemented, examples disclosed herein may apply to any relevant scenario in which a NAT service is implemented across multiple network devices serving underlying computing devices within a private network. As an example, client computing devices may connect to access network devices for network connectivity, where the access network devices are configured to provide access redundancy (e.g., as client computing devices move between access network devices). In such a scenario, the access network devices may serve, for example, as an anycast gateway for accessing other networks. These anycast gateway access network devices may, similar to the aggregation network devices discussed above, be configured to implement a NAT service, and use techniques similar to those discussed above to, when a NAT lookup miss occurs on a non-owner network device, cause the network data unit that caused the NAT lookup miss to be communicated directly to the NAT pool management owner for NAT assignment and transmission, with the NAT pool management owner then communicating the NAT assignment to the other access network devices for use in future communications within a given network flow.

Additionally, although the above description contemplates examples where a NAT service is implemented, techniques disclosed herein may be implemented on other scenarios where a network service is implemented across two or more network devices. As an example, a Transmission Control Protocol (TCP) connection may be established using a handshake process. In general, a client computing device seeking to establish a TCP connection sends a TCP Syn packet to a destination device. The destination device, in response, returns a TCP Syn-Ack packet to acknowledge the Syn packet from the client. Finally, the client acknowledges the Syn-Ack packet by sending a TCP Ack packet to the destination device.

However, when a client computing device may communicate with the destination device through two or more network devices (e.g., two or more aggregation network devices serving a LAG), such a handshake procedure may not operate properly. As an example, a TCP Syn packet from a client computing device may be transmitted through one network device, but the TCP Syn-Ack packet may be returned to another network device, which will drop the packet, causing a failure of the handshake process.

Examples disclosed herein may address such a problem by establishing a particular network device of a set of network devices (e.g., a set of aggregation network devices serving a particular LAG) as a TCP session establishment owner. In such a scenario, TCP handshake packets that go to non-owner network devices may be recognized by the non-owner devices, encapsulated using a VTEP of the non-owner device, and sent to the TCP session establishment owner. The TCP session establishment owner may then recognize the encapsulated packet as being a TCP handshake packet (e.g., based on a VNI included in the encapsulation), decapsulate the handshake packet, and process the packet (e.g., send to the destination device or to the client, depending on which stage of the handshake the packet corresponds to). Thus, the TCP session establishment owner will ultimately manage the TCP session establishment process, and then communicate relevant details of the TCP session to the non-owner devices.

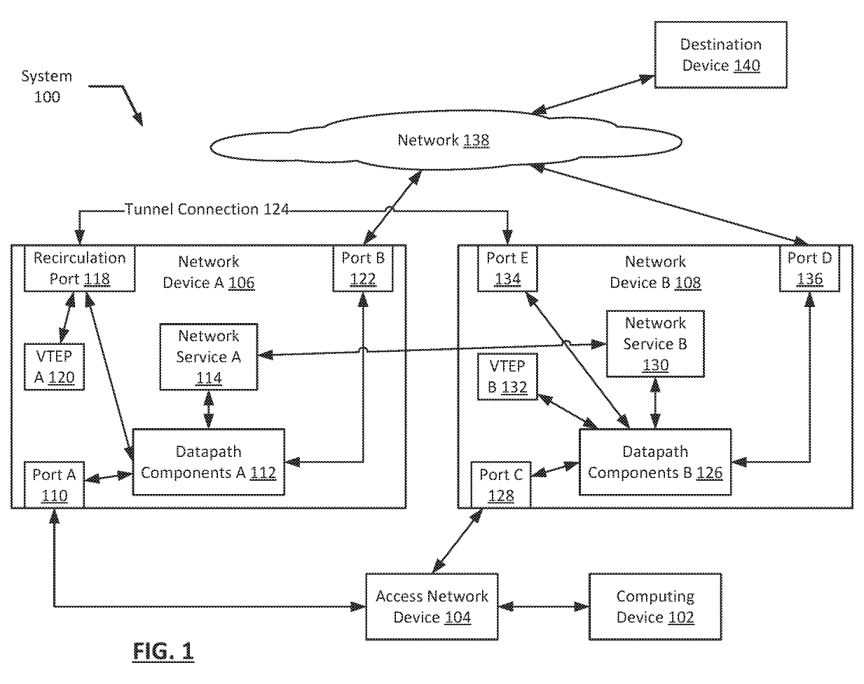

FIG. 1 shows a block diagram of a system for implementing a network service across multiple network devices in accordance with one or more examples disclosed herein. As shown in FIG. 1, the system 100 includes a computing device 102, an access network device 104, a network device A 106, a network device B 108, a network 138, and a destination device 140. The network device A 106 may include a port A 110, datapath components A 112, a network service A 114, a recirculation port 118, a VTEP A 120, and a port B 122. The network device B 108 may include a port C 128, datapath components B 126, a network service B 130, a VTEP B 132, a port E 134, and a port D 136. The network device A 106 and the network device B may be connected, for example, via a tunnel connection 124. Each of these components is discussed below.

In one or more examples, the computing device 102 is any device that may, from time to time, seek to communicate with other devices over a network (e.g., the network 138). The computing device 102 may also be referred to herein as a client computing device.

As used herein, a network (e.g., the network 138) may refer to an entire network or any portion thereof (e.g., a logical portion of the devices within a topology of devices). A network (e.g., the network 138) may include a datacenter network, a wide area network, a local area network, a wireless network, a cellular phone network, an InfiniBand network, and/or any other suitable network that facilitates the exchange of information from one part of the network to another (e.g., between devices within and/or connected to the network). A network may be a combination of any of the aforementioned network types. A network may be located at a single physical location or be distributed at any number of physical locations. In one or more examples, a network may be coupled with or overlap with, at least in part, the Internet.

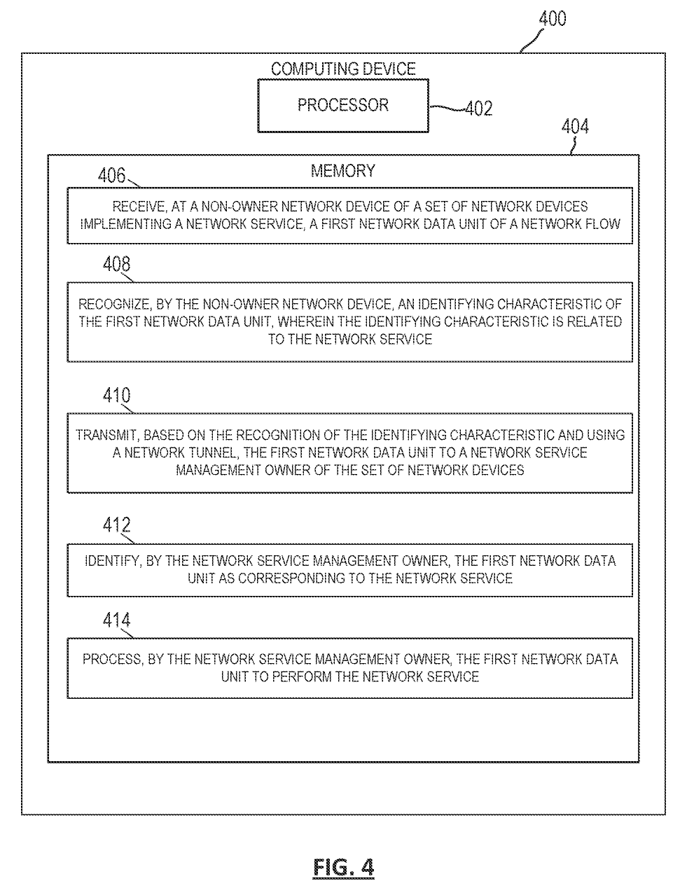

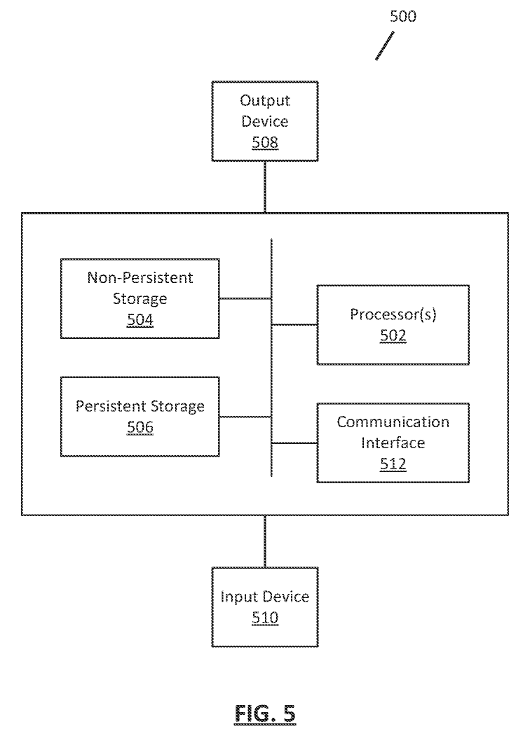

In one or more examples, as used herein, a computing device (e.g., the computing device 102) may be any single computing device, a set of computing devices, a portion of one or more computing devices, or any other physical, virtual, and/or logical grouping of computing resources. Non-limiting examples of a computing device are shown in FIGS. 4 and 5, which are described below. In one or more examples, a computing device may be any device of any type that is configured to host all or any portion of one or more operating systems, applications, microservices, clustered environment services, storage services, network services, and/or any other computing function, which may include executing instructions, performing operations, executing functions, performing computations, and the like.

In one or more examples, a computing device (e.g., the computing device 102) is any device, portion of a device, or any set of devices capable of electronically processing instructions and may include, but is not limited to, any of the following: one or more processors (e.g. components that include circuitry), memory (e.g., random access memory (RAM)), input and output device(s), non-volatile storage hardware (e.g., solid-state drives (SSDs), persistent memory (Pmem) devices, hard disk drives (HDDs)), one or more physical interfaces (e.g., network ports, storage ports), any number of other hardware components, and/or any combination thereof.

Examples of computing devices (e.g., the computing device 102) include, but are not limited to, a server (e.g., a blade-server in a blade-server chassis, a rack server in a rack, a desktop server, any other type of server device), a desktop computer, a mobile device (e.g., laptop computer, smart phone, personal digital assistant, tablet computer, automobile computing system, and/or any other mobile computing device), a storage device (e.g., a disk drive array, a fibre channel storage device, an Internet Small Computer Systems Interface (iSCSI) storage device, a tape storage device, a flash storage array, a network attached storage device, any other type of storage device), a network device, a virtual machine, a virtualized computing environment, a logical container (e.g., for one or more applications), a container pod, an Internet of Things (IoT) device, an array of nodes of computing resources, a supercomputing device, a data center or any portion thereof, any combination of the aforementioned items, and/or any other type of computing device. As one of ordinary skill in the art will appreciate, any of the aforementioned examples of computing devices necessarily require at least some hardware components.

In one or more examples, the storage and/or memory of a computing device or system of computing devices may be and/or include one or more data repositories for storing any number of data structures storing any amount of data (e.g., information). In one or more examples, a data repository is any type of storage unit and/or device (e.g., a file system, database, collection of tables, RAM, hard disk drive, solid state drive, and/or any other storage mechanism or medium) for storing data. Further, the data repository may include multiple different storage units and/or devices. The multiple different storage units and/or devices may or may not be of the same type or located at the same physical location.

Any storage and/or memory of a computing device or system of computing devices may be considered, in whole or in part, as non-transitory computer readable mediums storing software and/or firmware, which, when executed by one or more processors, cause the one or more processors to perform operations (e.g., execution of one or more computer programs) in accordance with one or more examples disclosed herein.

In one or more examples, the computing device 102 may be operatively connected to an access network device (e.g., the access network device A 104). In one or more examples, a network device is an example of one type of a computing device (discussed above). In one or more examples, the network device A 106 and the network device B 108 are also network devices.

In one or more examples, a network device (e.g., 104, 106, 108) also includes any number of additional components (not shown), such as, for example, network chips (not shown), field-programmable gate arrays (FPGAs) (not shown), application specific integrated circuits (ASICs) (not shown), indicator lights (not shown), fans (not shown), power supply units (not shown), power distribution units (not shown), and the like.

As an example, at least a portion of such hardware components may be included as part of what may be referred to as datapath components of a network device, such as the datapath components A 112 of the network device A 106 and the datapath components B 126 of the network device B 108. In one or more examples, datapath components (e.g., 112, 126), refers to a collection of hardware components (e.g., connected by a printed circuit board) that include any number of hardware components (e.g., ASICs, FPGAs, tertiary content addressable memories (TCAMs), processor components, other memory components, and the like) that are used, at least in part, to store information (e.g., forwarding information, NAT assignment information, and other information) in one or more hardware tables), and are configured to, at least, perform lookups using the stored information, and perform actions related to network data units based on such information to process network traffic.

Forwarding information may, for example, be stored (e.g., in various tables, not shown) in one or more hardware components of a network device, such as MAC tables, route table entries, multicast forwarding entries, and the like. Such forwarding information may be used to determine what actions to take when network data units are received by a network device (e.g., 104, 106, 108).

NAT assignment information may be stored, for example, in a NAT table (not shown). In one or more examples, a NAT table includes entries that store an association of IP addresses and port numbers of computing devices with NAT IP addresses and port numbers, as assigned to the computing device IP address and port number via a NAT assignment by a NAT pool management owner of a NAT service (discussed further below).

Datapath components (e.g., 112, 126), as discussed above, may include various components configured to perform actions based on lookups performed in the various hardware tables of the datapath components. Such actions may include, but are not limited to, performing a NAT lookup in a NAT table. Such a lookup may result in a NAT lookup hit, where information (e.g., an IP address and port number) from a network data unit is found in a NAT table. In one or more examples, a NAT lookup hit may result in further processing of the network data unit to update the network data unit (e.g., replace the source or destination IP address and port number of the network data unit with an IP address and port number found in the NAT table), and then further process the network data unit to transmit the network data unit towards its destination. NAT functionality is discussed further below.

A network device may (e.g., 104, 106, 108) also include information, such as a routing information base (RIB) that includes information (e.g., obtained from various routing protocols) that may be used to program components of the network device to propagate network data units. A network device may include any other components in any arrangement without departing from the scope of examples described herein, and, as such is not limited to any arrangement of components shown in any figure and/or described herein.

In one or more examples, as discussed above, a network device (e.g., 104, 106, 108) includes at least two physical interfaces, which may be referred to as ports. As an example, FIG. 1 shows the network device A 106 having the port A 110, the port B 122, and the recirculation port 118, and the network device B 108 as having the port C 128, the port E 134, and the port D 136. Although FIG. 1 shows these particular ports, which are discussed further below, a network device (e.g., the access network device 104, the network device A 106, the network device B 108) may have any number of ports without departing from the scope of examples disclosed herein. In one or more examples, physical interfaces are any hardware, software, or combination thereof that include functionality to receive and/or transmit network data units (e.g., packets, frames, and the like) or any other information to and/or from a network device. Physical interfaces may include any interface technology, such as, for example, optical, electrical, and the like. Physical interfaces may be configured to interface with any transmission medium (e.g., optical fiber, copper wire(s), and the like.).

In one or more examples, physical interfaces include and/or are operatively connected to any number of components used in the processing of network traffic, all or any portion of which may be considered part of the datapath components A 112 and/or the datapath components B 126 shown in FIG. 1. For example, a given physical interface may include a PHY (not shown), which is circuitry that connects a physical information propagation medium (e.g., a wire, not shown) to other components (e.g., the hardware components of a line card), which process network traffic. In one or more examples, physical interfaces include and/or are operatively connected to a transceiver, which provides the connection between the physical information transmission medium and the PHY. A PHY may also include any number of other components, such as, for example a serializer/deserializer (SERDES), and encoder/decoder, and the like. A PHY may, in turn, be operatively connected to other any number of other components, such as, for example, a media access control (MAC) sublayer. Such a sublayer, may, in turn, be operatively connected to still other higher layer processing components of a datapath (e.g., 112, 126), all of which form a series of components used in the processing of network traffic being received, transmitted, or otherwise used by a network device for any purpose.

In one or more examples, a network device (e.g., 104, 106, 108) includes any software (e.g., an operating system, various daemons, a state database, various services, and the like), firmware, and the like configured to perform and/or allow other components to perform various functions of the network device (e.g., to process network traffic, implement a NAT service, implement access control, monitor network usage, and the like). Such software may, for example, execute using one or more processors (not shown) of a network device (e.g., 104, 106, 108), or any other hardware resource of a network device capable of executing software. Any storage and/or memory (not shown) of a network device (e.g., 104, 106, 108) may be considered, in whole or in part, as non-transitory computer readable mediums storing software and/or firmware (e.g., computer programs), which, when executed by one or more processors (not shown) of the network device , cause the one or more processors to perform operations (e.g., execution of one or more computer programs) in accordance with one or more examples disclosed herein.

Examples of a network device (e.g., 104, 106, 108) include, but are not limited to, a switch, a router, a multilayer switch, a fibre channel device, an InfiniBand® device, and the like. A network device is not limited to the aforementioned specific examples. As an example, any computing device (discussed above) may be configured, at least in part, as a network device as used herein.

In one or more examples, as discussed above, a network device (e.g., 104, 106, 108) includes functionality to receive network data units (e.g., frames, packets, tunneling protocol frames, and the like) at any of the ports (e.g., 110, 118, 122, 128, 134, 136) of the network device, and to process the network data units (e.g., to receive, transmit, consume, update, and the like). In one or more examples, processing a network traffic includes, but is not limited to, a series of one or more lookups (e.g., longest prefix match (LPM) lookups, NAT lookup, forwarding equivalence class (FEC) lookups, and the like) and corresponding actions (e.g., forward from a certain egress port, add a labeling protocol header, rewrite a destination address, encapsulate, decapsulate, and the like). Examples of network traffic processing include, but are not limited to: (i) performing a NAT lookup as part of implementing a NAT service (ii) determining whether to take a security action (e.g., drop the network traffic data unit); (iii) determining whether to mirror the network traffic data unit; and/or (iv) determining how to route/forward the network traffic data unit in order to transmit the network traffic data unit from a port of the network device (e.g., 104, 106, 108). A network device (e.g., 104, 106, 108) may perform other actions, operations, functions, and the like with respect to a network data unit without departing from the scope of examples disclosed herein. Additionally, while a variety of possible configurations, components, and functionalities of a network device are discussed herein, any particular network device may be configured with some, but not all of the possible configurations, components, and functionalities of a network device.

As discussed above, a network device (e.g., 104, 106, 108) may be considered a type of computing device that is configured, at least in part, to provide network access and functionality for any number of other devices to which the network device is operatively connected.

In the example shown in FIG. 1, the computing device 102 is connected to a particular network device; the access network device 104. In one or more examples, the access network device 104 is configured to at least implement a bridging functionality, which may include, for example, processing network traffic based, at least in part, on L2 header information of network data units (e.g., MAC addresses). As an example, the access network device 104 may be configured to receive a network data unit from the computing device 102, perform a lookup in a forwarding table using MAC address information of the network data unit, and forward the network data unit towards its destination based at least in part on the result of the lookup.

In one or more examples, the access network device 104 is operatively connected to any number of other network devices. The example shown in FIG. 1 shows the access network device as being connected to two network devices, the network device A 106 and the network device B 108, and to the computing device 102. However, the access network device 104 may be connected to any number of other network devices and/or computing devices without departing from the scope of examples disclosed herein.

In one or more examples, a set of connections between the access network device 104 and other network devices (e.g., 106, 108) may be configured as a LAG. In one or more examples, a LAG is a configuration where multiple ports of a network device are combined into a single logical port. Such a configuration may, for example, provide connection redundancy for scenarios where one of the links in the LAG fails for any reason. In one or more examples, which link among the links in a configured LAG is used for propagating network traffic may be determined using any appropriate policy for distributing network traffic among two or more links (e.g., a round-robin policy, any other load balancing policy, and the like). As an example, when network traffic is received at the access network device 104 from the computing device 102, network data units of the network traffic may be propagated towards their destination using either the link between the access network device 104 and port A 110 of the network device A 106, or the link between the access network device 104 and the port C 128 of the network device B 108, based on an appropriate load balancing policy.

In one or more examples, network traffic from the computing device 102 may be destined for a particular location, such as, for example, the destination device 140. The destination device 140 may, for example, be a computing device (discussed above). In one or more examples, network traffic to (and from) a particular destination (e.g., the destination device 140) may be considered a network flow. A network flow may be network traffic that shares certain common characteristics, such as, for example, a common set of endpoints (e.g., source and destination) identified in network data units using various addresses (e.g., IP addresses) and port numbers.

In one or more examples, the network device A 106 and the network device B 108 may be configured as redundant network devices for connecting underlying devices (e.g., the computing device 102, the access network device 104) to other devices (e.g., the destination device 140) via a network (e.g., the network 138). At least a portion of the network 138 may include an external network (e.g., the Internet). Thus, the network device A 106 and the network device B 108 may be configured to perform routing functions as part of the set of actions, operations, and the like performed when network data units are received in order to propagate network data units towards their respective destinations. In one or more examples, because the network device A 106 and the network device B 108 provide connectivity between downstream devices (e.g., the computing device 102, the access network device 104) and upstream devices (e.g., the destination device 140) via the network 138, the network device A 106 and the network device B 108 may be considered as gateway network devices.

Additionally, because both the network device A 106 and the network device B 108 are configured to redundantly serve the LAG that includes connections from the access network device 104 (e.g., via port A 110 and port C 128), the network device A 106 and the network device B 108 may be considered to collectively form a gateway for the LAG. As such, the network device A 106 and the network device B 108 may be considered aggregation network devices, because they are aggregated together to provide certain functionalities for underlying devices (e.g., the computing device 102, the access network device 104), and, in particular, for one or more LAGs. Any suitable protocols, technologies, techniques, and the like may be used to allow for aggregation of network devices (e.g., the network device A 106, the network device B 108) without departing from the scope of examples disclosed herein. Examples of such suitable protocols, technologies, techniques, and the like may include, but are not limited to, EVPN, Virtual Switching Extension (VSX) and the like, which may, for example, include implementation of techniques by which the network devices may communicate with one another to implement various functionalities. As an example, the network devices may communicate with one another to share information regarding what one or more LAGs they are servicing. As another example, the network devices may communicate with one another in order to implement a common network service across the network devices. One example of such a network service is a NAT service. Other services may b e implemented across the network devices without departing from the scope of examples disclosed herein.

In one or more examples, the network device A 106 and the network device B 108 are configured to implement a NAT service. As an example, the network service A 114 of the network device A 106 may be a NAT service, and the network service B 130 of the network device B 108 may also be a NAT service, where the NAT service is implemented for the LAG that includes links from the access network device 104. A NAT service (e.g., 114, 130) may, for example, be a software service implemented on the network devices and executing on the respective one or more processors of the network devices.

In one or more examples, a NAT service (e.g., 114, 116) may allow any number of underlying devices (e.g., the computing device 102, the access network device 104) in a private network to access outside networks (e.g., the network 138) using a pool (not shown) of public Internet Protocol (IP) addresses and port numbers.

Specifically, a network device (e.g., 106, 108) implementing a NAT service (e.g., 114, 130) may maintain a NAT pool (not shown) of IP addresses and port numbers. When a network flow (e.g., network traffic communicated between two endpoint devices) is initiated (e.g., via receipt of a network data unit from an underlying client computing device destined for the destination device 140), the NAT service (e.g., 114, 130) may perform a lookup in a NAT table (e.g., in a hardware table of the datapath components A 112 or the datapath components B 126) to determine if a NAT IP address and port number from the NAT pool has been assigned (e.g., via a NAT assignment) to the client computing device (e.g., the computing device 102) for the network flow.

Because the network flow is being initiated (e.g., the first network data unit in the network flow), the NAT lookup may result in a NAT lookup miss. In the event of a NAT lookup miss, the NAT service may select a NAT IP address and port number from the NAT pool, assign the NAT IP address and port number to the IP address and port number corresponding to the client computing device and used for the network flow, and update its NAT table to reflect the assignment.

From that point on, during the network flow, network data units of the network flow from a client computing device (e.g., the computing device 102) are updated (e.g., translated) to include the NAT IP address and port number rather than the source IP address and port number of the client computing device. A similar process may happen in reverse for network data units of a network flow that are destined for a client computing device (e.g., the computing device 102). Thus, the NAT service (e.g., 114, 130) may function to translate the source IP address and port number to a NAT IP address and port number for outbound network flow traffic from a client computing device, and, similarly, translate the NAT IP address and port number back to the source IP address and port number for inbound network flow traffic to a client computing device.

As an example, a computing device (e.g., the computing device 102) seeking to communicate with another device (e.g., the destination device 140) over the Internet (e.g., part of the network 138) may send a network data unit (e.g., a packet) to an access network device (e.g., the access network device 104) to which the computing device is connected.

The network data unit may include (among other items of information) the IP address of the device with which communication is sought (e.g., the destination device 140) as a destination IP address, an IP address of the sending computing device (e.g., the computing device 102) as a source IP address, and a source port number. The access network device 104 may communicate the network data unit (e.g., based on a load balancing policy) to an aggregation network device (e.g., either the network device A 106 or the network device B 108) of a set of aggregation network devices to which the access network device 104 is connected via a set of links that form a LAG.

Upon receiving a network data unit from the underlying computing device 102 (e.g., via the access network device 104), an aggregation network device (e.g., 106, 108) implementing a NAT service (e.g., 114, 130) may perform a NAT lookup to determine if a NAT table (e.g., of the datapath components A 112 or the datapath components B 126) includes an entry matching the source IP address. When such an entry exists, the source IP address and port number of the network data unit may be replaced with a NAT IP address and port number assigned to the IP address of the computing device 102 (e.g., the initial source IP address of the network data unit) from a pool of NAT IP addresses and corresponding port numbers (e.g., the NAT pool 116). The updated network data unit may then be transmitted on towards its destination (e.g., the destination device 140).

A similar process may happen in reverse for incoming network traffic. As an example, when an aggregation network device (e.g., 106, 108) receives a network data unit, the destination IP address may be the NAT IP address assigned to a source IP address of a computing device (e.g., the computing device 102). The NAT IP address is used to lookup the IP address and port number of the computing device, and the network data unit is updated to include that IP address and port number rather than the NAT IP address and port number as the destination IP address and port number as the destination IP address and port number. The aggregation network device (e.g., 106, 108) may then transmit the network data unit to the access network device 104, which may then forward the network data unit to the appropriate computing device (e.g., the computing device 102) corresponding to the destination IP address and port number.

In scenarios in which a set of aggregation network devices service a particular LAG, such as the example configuration shown in FIG. 1, a NAT service may be implemented across the set of aggregation network devices serving the LAG, as shown by the instances of the network service (e.g., 114, 130) shown in FIG. 1. Because any of the aggregation network devices (e.g., 106, 108) implementing the NAT service (e.g., 114, 130) may be transmitting to or receiving from destination devices (e.g., the destination device 140) for network flows, one of the aggregation network devices is elected as an owner for the network service (e.g., a NAT pool management owner for the NAT service). The election may be performed using any suitable election technique (e.g., lowest switch virtual interface (SVI) IP number).

In the example system 100 configuration shown in FIG. 1, the network device A 106 has been elected as the owner network device (e.g., the NAT pool management owner). As such, the network device A 106 includes the NAT pool (not shown). As discussed above, in one or more examples, the NAT pool is a pool of IP addresses and port numbers to be used when network data units are transmitted to external networks (e.g., the network 138) towards a destination (e.g., the destination device 140). In one or more examples, the NAT pool management owner (e.g., the network device A 106) maintains the NAT pool, including selecting IP addresses and port numbers from the NAT pool when making NAT assignments, releasing IP addresses and port numbers when NAT assignments expire or are otherwise no longer needed, and the like. As discussed above, such NAT assignments are often made when a computing device initiates a network flow (e.g., sends the first network data unit in a communication flow using its IP address as the source IP address and using a particular port number as a source port number). The NAT pool management owner (e.g., the network device A 106) may make the assignment, and then communicate the assignment to the other aggregation network devices servicing the LAG (e.g., the network device B 108).

Each aggregation network device (e.g., the NAT pool management owner and the non-owner devices) may update their respective NAT tables, and subsequent network data units in the network flow may then use the NAT IP address and port number, regardless of which aggregation layer device receives the subsequent network data units of a network flow.

For a set of aggregation network devices implementing a network service (e.g., a NAT service) for a LAG (e.g., 106, 108), any aggregation network device that is not elected as the owner of the relevant service, such as a NAT pool management owner (e.g., the network device B 108) may be referred to as a non-owner network device. Thus, as an example, a non-owner network device for a NAT service (e.g., 114, 130) may be any aggregation network device serving the LAG and implementing the NAT service (e.g., via the NAT service 130), and that is not the elected NAT pool management owner.

In one or more examples, when a network data unit arrives at the port C 128 of the network device B 106 from the computing device 102 via the access network device 104, the network data unit may be passed to the datapath components B 126 of the network device B 108. Within this hardware datapath, a NAT lookup may be performed using a NAT table (not shown) of the datapath components B 126. When a NAT lookup miss occurs, a VTEP (e.g., the VTEP B 132) may be used to perform an encapsulation of the network data unit to obtain an encapsulated network data unit.

In one or more examples, a VTEP (e.g., the VTEP A 120, the VTEP B 132) is a function executing on a network device that is configured to encapsulate network data units before the network data units are sent to another device via a network tunnel connection (e.g., the tunnel connection 124), which may, as an example, be a VXLAN tunnel. A VTEP may be further configured to decapsulate encapsulated network data units that are received via a tunnel connection (e.g., the tunnel connection 124). In the example shown in FIG. 1, a port of the network device B (e.g., the port E 134) is connected to a certain port of the network device A (e.g., the recirculation port 118). As used herein, a recirculation port (e.g., the recirculation port 118) may be any port of a network device configured to receive encapsulated network data units via a tunnel connection (e.g., the tunnel connection 124).

In one or more examples, the encapsulation of a network data unit for which a NAT lookup miss occurred on the network device B 108 by the VTEP B 132 includes adding a particular VNI as part of the information encapsulating the network data unit. The encapsulated network data unit is then transmitted from port E 134 of the network device B 108 to the recirculation port 118 of the network device A 106.

The encapsulated network data unit may then be decapsulated by the VTEP A 120 of the network device A 106. The network device A 106 may also be configured to recognize that the network data unit is a network data unit for which a network service (e.g., a NAT assignment) is needed. Such recognition may occur, as an example, via determining the VNI included in the information encapsulating the network data unit.

In one or more examples, upon such a recognition that a NAT assignment is required, the network data unit may be provided to the datapath components A 112 of the network device A 106, as if, for example, the network data unit had been originally received by the network device A 106 from the access network device 104.

As part of traversing the datapath components A 112, a NAT lookup may be performed, using a NAT table of the datapath components A 112. In one or more examples, the NAT lookup results in a NAT lookup miss, which may cause the network device A 106 to invoke the NAT service 114 to make a NAT assignment. The NAT service 114 may then find a free IP address and port number in the NAT pool 116.

In one or more examples, once the NAT assignment is made by the NAT service 114 of the NAT pool management owner (e.g., the network device A 106), the NAT table of the network device A is updated to reflect the NAT assignment. The network data unit may then be updated based on the NAT assignment, and the updated network data unit may be transmitted towards its destination (e.g., the destination device 140).

In one or more examples, the network device A 106 separately communicates the NAT assignment information to the network device B 108, and, more specifically, to the NAT service 130 of the network device B 106. In one or more examples, the NAT service 130 then updates a NAT table of the datapath components B 126 of the network device B 108. Therefore, as an example, future network data units in the network flow between the computing device 102 and the destination device 140 may be processed by the datapath components B 126 of the network device B 106.

In one or more examples, using the above-described techniques for implementing a network service (e.g., a NAT service) for a LAG across two or more network devices may be improved, as the initial network data unit of a network flow may be transmitted from the network service owner (e.g., the NAT pool management owner) after the network data unit is processed by the datapath components of a non-owner network device, encapsulated by a VTEP of the non-owner network device, transmitted to a recirculation port of the network service owner (e.g., the NAT pool management owner), decapsulated, and processed by the network service owner, which may include, for example, performing some aspect of the network service (e.g., making the NAT assignment for the network data unit). Such an interaction may, for example, reduce the latency incurred via a software-to-software interaction between the network service B 130 and the network service A 114 before the network data unit may be transmitted towards its destination, and may, for example, improve various metrics associated with a network service (e.g., further improve the CPS metric for the NAT service, and make the CPS metric more consistent).

In one or more examples, although FIG. 1 shows the computing device 102 as connected to the network device A 106 and the network device B 108 via the access network device 104, examples disclosed herein are also applicable to scenarios where a network configuration includes any number of access network devices configured to function as anycast gateways for computing devices.

As an example, in some scenarios, computing devices may move between access network devices. As such, any of the access network devices may perform the function of communicating network data units of a network flow with destination devices on behalf of a particular computing device. In such a scenario, the access network devices may be similarly configured to implement a NAT service, with one of the access network devices configured to serve as the NAT pool management owner. Thus, in one or more examples, a non-owner access device may, in the event of a NAT lookup miss, use a VTEP to encapsulate the network data unit, and communicate the network data unit to the NAT pool management owner, which may decapsulate the network data unit, perform the NAT assignment, update the network data unit based on the NAT assignment, transmit the updated network data unit towards its destination, and communicate the NAT assignment to the other, non-owner access network devices.

Additionally, although the example shown in FIG. 1 is described in the context of network devices implementing a NAT service, other services implemented across two or more network devices may use similar techniques to those described above. As an example, the network device A 106 may be a TCP session establishment owner, and the network device B 108 may be a non-owner network device relative to the TCP session establishment process. In such a scenario, the network device B 108 may be configured to recognize any TCP handshake packets received at the network device B 108, encapsulate such a packet using the VTEP B 132 (including a particular VNI designated to identify TCP handshake packets), and transmit the encapsulated TCP handshake packet to the network device A 106 over the tunnel connection 124. The network device A, which is the TCP session establishment owner, may recognize the encapsulated packet (e.g., via the VNI therein), decapsulate the packet, and provide the packet to the datapath components A 112 for processing. In one or more examples, once the TCP session is established, the TCP session establishment owner may share information about the TCP session with non-owner network devices. Using such techniques, the TCP session establishment process may be improved, as TCP handshake packets that happen to be received at different network device will not cause a failure or necessitate a retry of the TCP session establishment process.

While FIG. 1 shows a particular configuration of components, other configurations may be used without departing from the scope of examples described herein. For example, although FIG. 1 shows certain components as part of the same device, any of the components may be grouped in sets of one or more components which may exist and execute as part of any number of separate and operatively connected devices. As another example, a single component may be configured to perform all or any portion of the functionality performed by all or any portion of the components shown in FIG. 1. Accordingly, examples disclosed herein should not be limited to the configuration of components shown in FIG. 1.

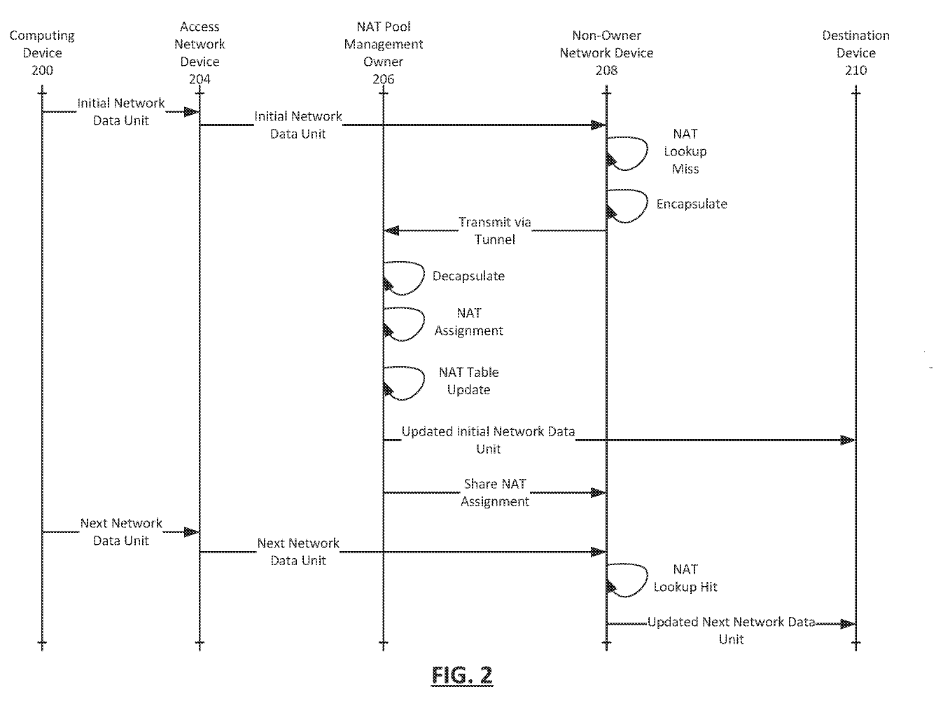

FIG. 2 shows a flow diagram of an example interaction between network devices implementing a NAT service in accordance with one or more examples disclosed herein. The example shown in FIGS. s and discussed below is a highly simplified example intended for explanatory purposes only, and not intended to limit the scope of examples disclosed herein. One of ordinary skill in the art, having the benefit of this disclosure, will appreciate that examples disclosed herein may include any number of network devices configured to implement a NAT service (e.g., more than two), that a computing device may communicate directly with a NAT pool management owner or non-owner network device instead of through an access network device, that a service other than a NAT service (e.g., a TCP session establishment service) may be implemented across network devices but use similar techniques, and the like.

Referring to FIG. 2, consider a scenario in which a computing device 200 seeks to initiate a network flow with a destination device 210. In such a scenario, the computing device 200 is operatively connected to an access network device 204. The access network device may be operatively connected to each of a NAT pool management owner 206 (e.g., the network device A of FIG. 1) and a non-owner network device 208 (e.g., the network device B 108 of FIG. 1). The link from the access network device 204 to the NAT pool management owner 206 and to the non-owner network device 208 may be configured as a LAG.

As shown in FIG. 2. in such a scenario, the computing device 200 may transmit an initial network data unit of the network flow to the non-owner network device 208 based on a load balancing policy configured for the LAG. In response to receipt of the initial network data unit, the non-owner network device may perform a NAT lookup using a NAT table of the non-owner network device 208. In this example, the result of the NAT lookup is a NAT lookup miss, as a NAT assignment has not yet been made for the network flow.

In response to the NAT miss, a VTEP of the non-owner network device 208 may be invoked to perform an encapsulation of the network data unit. The encapsulation may include a particular VNI intended to communicate to the NAT pool management owner that a NAT assignment is needed for the network data unit. The encapsulated network data unit may then be transmitted from the non-owner network device 208 to a recirculation port of the NAT pool management owner 206 via a network tunnel (e.g., a VXLAN tunnel).

In response to receiving the encapsulated network data unit, the NAT pool management owner 206 may assess the encapsulated network data unit and, based at least in part on the VNI, determine that a NAT assignment is needed. Accordingly, the encapsulated network data unit may be decapsulated by a VTEP of the NAT pool management owner 206, and provided to datapath components of the NAT pool management owner 206. The network data unit may then be processed by the data path components, including performing a NAT lookup, which results in a NAT lookup miss.

In response to the NAT lookup miss, A NAT service of the NAT pool management owner 206 may make a NAT assignment for the network data unit from a NAT pool maintained by the NAT pool management owner 206. In one or more examples, the NAT table of the NAT pool management owner is then updated to reflect the NAT assignment, the network data unit is updated to include the NAT IP address and port number of the NAT assignment, and the updated network data unit is transmitted towards the destination device 210.

In one or more examples, the NAT assignment is then shared from the NAT pool management owner 206 to the non-owner network device 208 using whatever communication protocol is configured for software-to-software communication between the NAT service instances on the two network devices (e.g., EVPN, VSX, and the like).

The non-owner network device 208 may then update its NAT table to reflect the NAT assignment. Sometime later, a next network data unit of the same network flow is transmitted from the computing device 200 to the access network device 204. The access network device 204 then, based on a configured load balancing policy, transmits the next network data unit to the non-owner network device 208.

The non-owner network device 208 then performs a NAT lookup using its NAT table, which results in a NAT lookup hit, as the NAT table has been updated, as discussed above, with the NAT assignment from the NAT pool management owner. Therefore, the non-owner network device updates the network data unit to include the NAT IP and port number from the NAT assignment, and transmits the updated next network data unit towards the destination device 210.

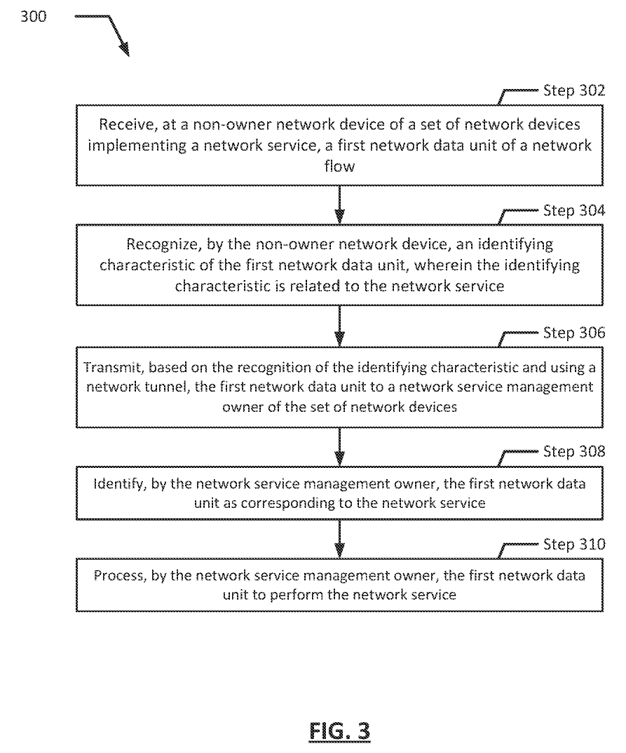

FIG. 3 illustrates an overview of an example method 300 for implementing a network service (e.g., a NAT service, a TCP session establishment service, and the like) across multiple network device in accordance with one or more examples disclosed herein.

The method 300 may be performed, at least in part, by one or more devices and/or components of the system shown in FIG. 1. As such, all or any portion of the method 300 may be performed, for example, by one or more network devices (e.g., the network device A 106 of FIG. 1, the network device B 108 of FIG. 1).

While the various steps in the flowchart shown in FIG. 3 are presented and described sequentially, some or all of the steps may be executed in different orders, some or all of the steps may be combined or omitted, and some or all of the steps may be executed in parallel with other steps of FIG. 3 and/or steps not shown in FIG. 3.

In Step 302, the method 300 includes receiving, at a non-owner network device of a set of network devices implementing a network service, a first network data unit of a network flow. As an example, Step 302 may include receiving, at a non-owner network device of a set of network devices implementing a network address translation (NAT) service, a first network data unit of a network flow. In one or more examples, the non-owner network device is a network device that is configured to implement a network service, but that is not elected as the owner of the network service. As an example, the non-owner network device may be a network device that is included in a set of network devices that is configured to implement a NAT service, but that is not elected as a NAT pool management owner for the NAT service (e.g., the network device B 108 of FIG. 1). In one or more examples, the first network data unit is received from a computing device (e.g., the computing device 102 of FIG. 1). In some examples, the first network data unit is received from the computing device via an access network device (e.g., the access network device 104 of FIG. 1). In other examples, the first network data unit is received at the non-owner network device directly from the computing device (e.g., in a scenario where a set of access network devices are configured as an anycast gateway for underlying computing devices).

In Step 304, the method 300 includes recognizing, by the non-owner network device, an identifying characteristic of the first network data unit, wherein the identifying characteristic is related to the network service. In one or more examples, an identifying characteristic of the first network data unit is any characteristic that identifies the network data unit as being a network data unit for which a network service is needed. Such characteristics may include, but are not limited to, addresses (e.g., IP addresses), other header information, and the like. As an example, an identifying characteristic may be recognized by performing a first NAT lookup using a source address of the first network data unit. In one or more examples, the NAT lookup is performed using a NAT table of the non-owner network device. The NAT table may, for example, be implemented as a hardware table as part of a set of datapath components of the non-owner network device (e.g., the datapath components B 126 of FIG. 1). In one or more examples, the source address is an IP address of the computing device from which the first network data unit was received. The lookup may further include using a source port number of the first network data unit. In one or more examples, the NAT lookup determines whether a NAT assignment has previously been made for the source address (e.g., whether an entry exists corresponding to the source IP address and port number). Thus, in such a scenario, the source IP address leading to a NAT lookup miss may be considered as the identifying characteristic. As another example, an identifying characteristic may be an aspect of the first network data unit that identifies the first network data unit as being part of a TCP handshake process (e.g., a SYN flag set to 1 in the message, an initial sequence number is included in the packet, and the like).

In Step 306, the method 300 includes transmitting, based on the recognition of the identifying characteristic and using a network tunnel, the first network data unit to a network service management owner of the set of network devices. As an example, Step 306 may include transmitting, when a NAT lookup results in a NAT lookup miss, the first network data unit to a NAT pool management owner of the set of network devices. In one or more examples, a NAT pool management owner is a network device is included in a set of network devices that is configured to implement a NAT service, but that is elected as a NAT pool management owner for the NAT service (e.g., the network device B 108 of FIG. 1) using any suitable election technique. In one or more examples, a NAT lookup miss occurs when the information used to perform the lookup (e.g., a source IP address and port number) from the first network data unit is not found in a corresponding entry of the NAT table. In one or more examples, transmitting the first network data unit to the NAT pool management owner includes encapsulating the first network data unit to obtain an encapsulated first network data unit. In one or more examples, the encapsulation includes various items of information that allow the NAT pool management owner to identify the first network data unit as needing a NAT assignment. As an example, the encapsulated first network data unit may include a particular VNI, and the NAT pool management owner may be configured to recognize the VNI as indicating that the first network data unit requires a NAT assignment. In one or more examples, the transmission of the encapsulated first network data unit is performed using a network tunnel (e.g., a VXLAN tunnel) between the non-owner network device and a recirculation port (e.g., the recirculation port 112 of FIG. 1) of the NAT pool management owner. In one or more examples, the encapsulation of the first network data unit is performed by a VTEP executing on the non-owner network device.

In Step 308, the method 300 includes identifying, by the network service management owner, the first network data unit as corresponding to the network service. As discussed above, the network service management owner may identify the first network data unit as corresponding to the network service using any suitable technique for making the identification, such as, for example, assessing a VNI included in an encapsulation header of the encapsulated first network data unit.

In Step 310, the method 300 includes processing, by the network service management owner, the first network data unit to perform the network service. As an example, performing the network service may include making, by a NAT pool management owner and using a source address of the first network data unit, a NAT assignment for the source address. In one or more examples, the first network data unit, after receipt by the NAT pool management owner, is provided to datapath components of the NAT pool management owner (e.g., the datapath components A 112 of FIG. 1) for processing. In one or more examples, the processing includes performing a NAT lookup using the source address (e.g., the source IP address and port number) in a NAT table of the NAT pool management owner, which results in a NAT lookup miss. In one or more examples, in response to the NAT lookup miss, a NAT service (e.g., the NAT service 114 of FIG. 1) of the NAT pool management owner may make the NAT assignment using a NAT pool of the NAT pool management owner. In one or more examples, the NAT assignment includes a NAT IP address and port number associated with the source IP address and port number. In one or more examples, the NAT pool management owner receives the first network data unit as an encapsulated first network data unit via a network tunnel (e.g., the tunnel connection 124 of FIG. 1). Accordingly, in some examples, the encapsulated first network data unit may be decapsulated by a VTEP of the NAT pool management owner (e.g., the VTEP A 120 of FIG. 1) prior to being provided to the datapath components of the NAT pool management owner.

Continuing the above example, performing the network service, where the network service is a NAT service, may include updating a NAT pool management owner NAT table of the NAT pool management owner with the NAT assignment. In one or more examples, the NAT table of the NAT pool management owner is a hardware table included in the datapath components of the NAT pool management owner. In one or more examples, updating the NAT pool management owner NAT table includes adding or updating an entry of the NAT table to include the NAT assignment.

Performing the network service, where the network service is a NAT service, may further include updating the first network data unit based on the NAT assignment to obtain an updated first network data unit. In one or more examples, updating the first network data unit includes replacing the source IP address and port number of the first network data unit with the NAT IP address and port number identified in the NAT table based on the NAT assignment.

Performing the network service, where the network service is a NAT service, may further include transmitting the updated first network data unit towards a destination. In one or more examples, the updated first network data unit is transmitted towards a destination device (e.g., the destination device 140 of FIG. 1) based on destination information included in the first network data unit. In one or more examples, the updated first network data unit is transmitted towards the destination via an appropriate interface of the NAT pool management owner (e.g., port B 122 of FIG. 1).

Performing the network service, where the network service is a NAT service, may include communicating the NAT assignment to the non-owner network device and other devices of the set of network devices. In one or more examples, the NAT assignment is communicated from the NAT pool management owner to the non-owner network device using any suitable communication protocol, technique, and/or connection that allows the two devices to share information with one another (e.g., EVPN, VSX, and the like). In one or more examples, the NAT assignment is shared from the NAT pool management owner to any number of network devices that implement a NAT service. As an example, the NAT assignment may be shared from the NAT pool management owner to any number of non-owner network devices that, along with the NAT pool management owner, service a particular LAG. As another example, the NAT assignment may be shared from the NAT pool management owner to any number of non-owner network devices that, along with the NAT pool management owner, and collectively configured to server as an anycast gateway for underlying computing devices.

In one or more examples, once the non-owner network device receives the NAT assignment, the non-owner network device may update its NAT table to include the NAT assignment. After such an update, network data units from the same network flow as the first network data unit (e.g., a second network data unit of the same network flow) that are subsequently received at the non-owner network device will, when a NAT lookup is performed, result in a NAT lookup hit, be updated based on the NAT assignment, and transmitted towards the destination.

FIG. 4 illustrates a block diagram of a computing device 400, in accordance with one or more examples disclosed herein. The computing device 400 may be an example of all or any portion of the components shown in FIG. 1 (e.g., the network device A 106, the network device B 108) and described above, and/or of the computing device 500, described below. In some examples, the computing device 400 may be considered a logical representation of a computing device which may, for example, be implemented across two or more physical devices (e.g., the network device A 106, the network device B 108). As discussed above in the descriptions of FIGS. 1, 2, and 3, the computing device 400 may be used to implement all or any portion of the various components shown in FIG. 1 and described above and/or to perform all or any portion of the method 300 shown in FIG. 3 and described above.

The computing device 400 may include one or more processors 402 and memory 404. The memory 404 may include a non-transitory computer-readable medium that stores programming for execution by one or more of the one or more processors 402. In this implementation, one or more modules within the computing device 400 may be partially or wholly embodied, at least in part, as software for performing any functionality described in this disclosure. The computing device 400 may be, for example, configured to perform the method 300 shown in FIG. 3 and described above, by executing instructions included in the memory 404 and executed by the one or more processors 402.

For example, the memory 404 may include instructions 406 to receive, at a non-owner network device of a set of network devices implementing a network service, a first network data unit of a network flow (e.g., as described above in reference to Step 302 of FIG. 3).

For example, the memory 404 may include instructions 408 to recognize, by the non-owner network device, an identifying characteristic of the first network data unit, wherein the identifying characteristic is related to the network service (e.g., as described above in reference to Step 304 of FIG. 3).

For example, the memory 404 may include instructions 410 to transmit, based on the recognition of the identifying characteristic and using a network tunnel, the first network data unit to a network service management owner of the set of network devices (e.g., as described above in reference to Step 306 of FIG. 3).

For example, the memory 404 may include instructions 412 to identify, by the network service management owner, the first network data unit as corresponding to the network service (e.g., as described above in reference to Step 308 of FIG. 3).

For example, the memory 404 may include instructions 414 to process, by the network service management owner, the first network data unit to perform the network service (e.g., as described above in reference to Step 310 of FIG. 3).

FIG. 5 illustrates a block diagram of a computing device 500, in accordance with one or more examples of this disclosure. As discussed above, examples described herein may be implemented, at least in part, using computing devices (e.g., network devices), and the computing device 500 shown in FIG. 5 may be such a computing device. For example, all or any portion of the components shown in FIG. 1 (e.g., the network device A 106, the network device B 108) may be implemented, at least in part using a computing device such as the computing device 500, and may include all or any portion of the components of the computing device 500 shown in FIG. 5 and described below.

In one or more examples, a computing device (e.g., the computing device 500) is any device, portion of a device, or any set of devices capable of electronically processing instructions and may include, but is not limited to, any of the following: one or more processors (e.g. components that include circuitry) (e.g., the processor 502), memory (e.g., random access memory (RAM)) (not shown), input and output device(s) (e.g., the non-persistent storage 506), non-volatile storage hardware (e.g., solid-state drives (SSDs), persistent memory (Pmem) devices, hard disk drives (HDDs) (not shown)), one or more physical interfaces (e.g., network ports, storage ports) (e.g., the persistent storage 506), any number of other hardware components (not shown), and/or any combination thereof. As used herein, a processor may be any component that can be configured to execute operations, processes, threads, and the like. In some examples, a computing device (e.g., the computing device 500) may include any number of homogeneous or heterogeneous processors of any type.

The computing device 500 may include a communication interface 512 (e.g., Bluetooth interface, infrared interface, network interface, optical interface, any other type of communication interface), input devices 510, output devices 508, and numerous other elements (not shown) and functionalities. Each of these components is described below.

In one or more examples, the computer processor(s) 502 may be an integrated circuit for processing instructions. For example, the computer processor(s) may be one or more cores or micro-cores of a processor. The processor 502 may be a general-purpose processor configured to execute program code included in software executing on the computing device 500. The processor 502 may be a special purpose processor where certain instructions are incorporated into the processor design. The processor 502 may be a central processing unit (CPU), a multi-core CPU, an application specific integrated circuit (ASIC), a graphics processing unit (GPU), a data processing unit (DPU), a tensor processing units (TPU), an associative processing unit (APU), a vision processing units (VPU), a quantum processing unit (QPU), and/or various other processing units that use special purpose hardware (e.g., field programmable gate arrays (FPGAs), System-on-a-Chips (SOCs), digital signal processors (DSPs)). Although only one processor 502 is shown in FIG. 5, the computing device 500 may include any number of processors without departing from the scope of examples disclosed herein.

The computing device 500 may also include one or more input devices 510, such as a touchscreen, keyboard, mouse, microphone, touchpad, electronic pen, motion sensor, or any other type of input device. The input devices 510 may allow a user to interact with the computing device 500. In one or more examples, the computing device 500 may include one or more output devices 508, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 502, non-persistent storage 504, and persistent storage 506. Many different types of computing devices exist, and the aforementioned input and output device(s) may take other forms. In some instances, multimodal systems can allow a user to provide multiple types of input/output to communicate with the computing device 500.

Further, the communication interface 512 may facilitate connecting the computing device 500 to a network (not shown) (e.g., a local area network (LAN), a wide area network (WAN) such as the Internet, mobile network, or any other type of network) and/or to another device, such as another computing device. The communication interface 512 may perform or facilitate receipt and/or transmission of wired or wireless communications using wired and/or wireless transceivers of any type and/or technology. Examples include, but are not limited to, those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 512 may also include one or more Global Navigation Satellite System (GNSS) receivers or transceivers that are used to determine a location of the computing device 500 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The term computer-readable medium includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, and the like may be passed, forwarded, or transmitted via any suitable means including memory sharing, message passing, token passing, network transmission, or the like.

All or any portion of the components of the computing device 500 may be implemented in circuitry. For example, the components can include and/or can be implemented using electronic circuits or other electronic hardware, which can include one or more programmable electronic circuits (e.g., microprocessors, GPUs, DSPs, FPGAs, CPUs, CAMs, and/or other suitable electronic circuits), and/or can include and/or be implemented using computer software, firmware, or any combination thereof, to perform the various operations described herein. In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

In the above description, numerous details are set forth as examples described herein. It will be understood by those skilled in the art (who also have the benefit of this disclosure) that one or more examples described herein may be practiced without these specific details, and that numerous variations or modifications may be possible without departing from the scope of the examples described herein. Certain details known to those of ordinary skill in the art may be omitted to avoid obscuring the description.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including functional blocks that may include devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects of examples disclosed herein.

Individual aspects may be described above as a process or method which is depicted as a flowchart, a flow diagram, a data flow diagram, a structure diagram, or a block diagram. Although a flowchart or flow diagram may describe the operations as a sequential process, many of the operations can be performed in parallel or concurrently. In addition, the order of the operations may be re-arranged. A process may be terminated when its operations are completed, but may have additional steps not included in a drawing. A process may correspond to a method, a function, a procedure, a subroutine, a subprogram, and the like. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, a network device, or a processing device (e.g., one or more processors) to perform a certain function or group of functions. Portions of computer resources used can be accessible over a network. The computer executable instructions may be, for example, binaries, intermediate format instructions such as assembly language, firmware, source code, and the like. Examples of computer-readable media that may be used to store instructions, information used, and/or information created during methods according to described examples include magnetic or optical disks, flash memory, USB devices provided with non-volatile memory, networked storage devices, and the like.

In the above description of the figures, any component described with regard to a figure, in various examples described herein, may be equivalent to one or more same or similarly named and/or numbered components described with regard to any other figure. For brevity, descriptions of these components may not be repeated with regard to each figure. Thus, each and every example of the components of each figure is incorporated by reference and assumed to be optionally present within every other figure having one or more same or similarly named and/or numbered components. Additionally, in accordance with various examples described herein, any description of the components of a figure is to be interpreted as an optional example, which may be implemented in addition to, in conjunction with, or in place of the examples described with regard to a corresponding one or more same or similarly named and/or numbered component in any other figure.

Throughout the application, ordinal numbers (e.g., first, second, third) may be used as an adjective for an element (i.e., any noun in the application). The use of ordinal numbers is not to imply or create any particular ordering of the elements, nor to limit any element to being only a single element unless expressly disclosed, such as by the use of the terms "before", "after", "single", and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, operative connection, and variations thereof, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While examples discussed herein have been described with respect to a limited number of examples, those skilled in the art, having the benefit of this disclosure, will appreciate that other examples can be devised which do not depart from the scope of examples as disclosed herein. Accordingly, the scope of examples described herein should be limited only by the attached claims.

What is claimed is:

1. A system, comprising:
a network service management owner, comprising:
datapath components;
one or more processors
a network service executing on the one or more processors; and
wherein the network service management owner is configured to:
receive, via a network tunnel, a first network data unit of a network flow, wherein:
the network service management owner is part of a set of network devices implementing the network service;
the set of network devices further comprises a non-owner network device;
the first network data unit is received from the non-owner network device;
the first network data unit comprises an identifying characteristic related to the network service; and
the first network data unit is transmitted from the non-owner network device to the network service management owner based at least in part on the non-owner network device recognizing the identifying characteristic;
identify the first network data unit as corresponding to the network service; and
process the first network data unit to perform the network service.

2. The system of claim 1, wherein:
the network service is a NAT service,
the network service management owner is a NAT pool management owner,
the identifying characteristic is a source address of the first network data unit used by the non-owner network device to perform a NAT lookup resulting in a NAT lookup miss, and
to process the first network data unit to perform the network service, the NAT pool management owner is further configured to:
make, via the NAT service and using the source address, a NAT assignment for the source address;
update a NAT pool management owner NAT table of the NAT pool management owner with the NAT assignment;
update, using the datapath components, the first network data unit based on the NAT assignment to obtain an updated first network data unit;
transmit, via the datapath components, the updated first network data unit towards a destination; and
communicate the NAT assignment to the non-owner network device.

3. The system of claim 2, further comprising the non-owner network device, wherein the non-owner network device is configured to:
update, after transmission of the updated first network data unit to the destination by the NAT pool management owner, a non-owner network device NAT table of the non-owner network device based on the NAT assignment.

4. The system of claim 3, wherein the non-owner network device is further configured to:
receive, after the non-owner network device receives the NAT assignment from the NAT pool management owner, a second network data unit of the network flow;
perform a second NAT lookup using the source address of the second network data unit, wherein the second NAT lookup results in a NAT lookup hit;
update the second network data unit based on the NAT assignment to obtain an updated second network data unit; and
transmit the updated second network data unit towards the destination.

5. The system of claim 2, wherein the NAT assignment comprises a NAT pool Internet Protocol (IP) address and a port number.

6. The system of claim 2, wherein:
the first network data unit is received by the NAT pool management owner using the network tunnel,
the non-owner network device is configured to:
encapsulate, before the first network data unit is transmitted and by the non-owner network device, the first network data unit to obtain an encapsulated first network data unit; and
the NAT pool management owner is further configured to:
decapsulate the encapsulated first network data unit to obtain the first network data unit.

7. The system of claim 1, wherein the set of network devices comprises:
a plurality of aggregation network devices, each serving a particular link aggregation group, or
a plurality of access network devices configured to collectively function as an anycast gateway.

8. The system of claim 1, wherein:
the network service is a Transmission Control Protocol (TCP) session establishment service,
the network service management owner is a TCP session establishment owner,
the identifying characteristic identifies that the first network data unit is part of a TCP handshake procedure, and
to process the first network data unit to perform the network service, the TCP session establishment owner is further configured to:
process, using the datapath components, the first network data unit to transmit the first network data unit towards a destination identified in the first network data unit; and
manage an establishment of a TCP session for which the TCP handshake procedure is performed, at least in part, using the first network data unit; and
provide, after the establishment, information corresponding to the TCP session to the non-owner network device.

9. A computer-implemented method, comprising:
receiving, at a non-owner network device of a set of network devices implementing a network service, a first network data unit of a network flow;
recognizing, by the non-owner network device, an identifying characteristic of the first network data unit, wherein the identifying characteristic is related to the network service;
transmitting, based on the recognition of the identifying characteristic and using a network tunnel, the first network data unit to a network service management owner of the set of network devices;
identifying, by the network service management owner, the first network data unit as corresponding to the network service; and
processing, by the network service management owner, the first network data unit to perform the network service.

10. The computer-implemented method of claim 9, wherein:
the network service is a NAT service,
the network service management owner is a NAT pool management owner,
the identifying characteristic is a source address of the first network data unit used by the non-owner network device to perform a NAT lookup resulting in a NAT lookup miss, and
processing the first network data unit to perform the network service comprises:
making, by the NAT pool management owner and using the source address, a NAT assignment for the source address;
updating a NAT pool management owner NAT table of the NAT pool management owner with the NAT assignment;
updating the first network data unit based on the NAT assignment to obtain an updated first network data unit;
transmitting the updated first network data unit towards a destination; and
communicating the NAT assignment to the non-owner network device and other devices of the set of network devices.

11. The computer-implemented method of claim 10, further comprising:
updating, by the non-owner network device and after transmission of the updated first network data unit to the destination by the NAT pool management owner, a non-owner network device NAT table of the non-owner network device based on the NAT assignment.

12. The computer-implemented method of claim 11, further comprising:
receiving, at the non-owner network device and after the non-owner network device receives the NAT assignment from the NAT pool management owner, a second network data unit of the network flow;
performing a second NAT lookup using the source address of the second network data unit, wherein the second NAT lookup results in a NAT lookup hit;
updating the second network data unit based on the NAT assignment to obtain an updated second network data unit; and
transmitting the updated second network data unit towards the destination.

13. The computer-implemented method of claim 10, wherein the NAT assignment comprises a NAT pool Internet Protocol (IP) address and a port number.

14. The computer-implemented method of claim 10, wherein:
the first network data unit is transmitted to the NAT pool management owner using the network tunnel, and
the computer-implemented method further comprises:
encapsulating, before the first network data unit is transmitted and by the non-owner network device, the first network data unit to obtain an encapsulated first network data unit; and
decapsulating, by the NAT pool management owner, the encapsulated first network data unit to obtain the first network data unit.

15. The computer-implemented method of claim 9, wherein:
the set of network devices comprises a plurality of aggregation network devices, each serving a particular link aggregation group, or
the set of network devices comprises a plurality of access network devices configured to collectively function as an anycast gateway.

16. The computer-implemented method of claim 9, wherein:
the network service is a Transmission Control Protocol (TCP) session establishment service,
the network service management owner is a TCP session establishment owner,
the identifying characteristic identifies that the first network data unit is part of a TCP handshake procedure, and
processing the first network data unit to perform the network service comprises:
processing, by the TCP session establishment owner, the first network data unit to transmit the first network data unit towards a destination identified in the first network data unit; and
managing, by the TCP session establishment owner, an establishment of a TCP session for which the TCP handshake procedure is performed using, at least in part, the first network data unit; and
providing, , by the TCP session establishment owner and after the establishment, information corresponding to the TCP session to the non-owner network device.

17. A non-transitory computer-readable medium storing programming for execution by one or more processors, the programming comprising instructions to:
receive, at a non-owner network device of a set of network devices implementing a network service, a first network data unit of a network flow;
recognize, by the non-owner network device, an identifying characteristic of the first network data unit, wherein the identifying characteristic is related to the network service;
transmit, based on the recognition of the identifying characteristic and using a network tunnel, the first network data unit to a network service management owner of the set of network devices;
identify, by the network service management owner, the first network data unit as corresponding to the network service; and
process, by the network service management owner, the first network data unit to perform the network service.

18. The non-transitory computer-readable medium of claim 17, wherein:
the network service is a NAT service,
the network service management owner is a NAT pool management owner,
the identifying characteristic is a source address of the first network data unit used by the non-owner network device to perform a NAT lookup resulting in a NAT lookup miss, and
to process the first network data unit to perform the network service, the programming comprises further instructions to:
make, by the NAT pool management owner and using the source address, a NAT assignment for the source address;
update a NAT pool management owner NAT table of the NAT pool management owner with the NAT assignment;
update the first network data unit based on the NAT assignment to obtain an updated first network data unit;
transmit the updated first network data unit towards a destination; and
communicate the NAT assignment to the non-owner network device and other devices of the set of network devices.

19. The non-transitory computer-readable medium of claim 18, wherein the programming comprises further instructions to:
update, by the non-owner network device and after transmission of the updated first network data unit to the destination by the NAT pool management owner, a non-owner network device NAT table of the non-owner network device based on the NAT assignment;
receive, at the non-owner network device and after the non-owner network device receives the NAT assignment from the NAT pool management owner, a second network data unit of the network flow;
perform a second NAT lookup using the source address of the second network data unit, wherein the second NAT lookup results in a NAT lookup hit;
update the second network data unit based on the NAT assignment to obtain an updated second network data unit; and
transmit the updated second network data unit towards the destination.

20. The non-transitory computer-readable medium of claim 17, wherein:
the network service is a Transmission Control Protocol (TCP) session establishment service,
the network service management owner is a TCP session establishment owner,
the identifying characteristic identifies that the first network data unit is part of a TCP handshake procedure, and
to process the first network data unit to perform the network service, the programming comprises further instructions to:
process, by the TCP session establishment owner, the first network data unit to transmit the first network data unit towards a destination identified in the first network data unit; and
manage, by the TCP session establishment owner, an establishment of a TCP session for which the TCP handshake procedure is performed using, at least in part, the first network data unit; and
provide, by the TCP session establishment owner and after the establishment, information corresponding to the TCP session to the non-owner network device.
